(19) United States
(12) Patent Application Publication
(10) Pub. No.: US 2006/0239770 A1
(43) Pub. Date: Oct. 26, 2006

(54) Swivel coupling device for coupling assembly

(76) Inventor: Le Cheng Liu, Tuchern City (TW)

Correspondence Address: CHARLES E. BAXLEY, ESQ., 90 JOHN STREET, THIRD FLOOR, NEW YORK, NY, 10038, US

(21) Appl. No.: 11/027,047

(22) Filed: Dec. 30, 2004

(51) Int. Cl. F16C 11/06

(52) U.S. Cl. 403/161

(57) ABSTRACT

A coupling assembly includes a swivel coupling device for attaching to a coupling member, and includes a housing having a chamber formed by an inner peripheral surface, and having an inner peripheral groove formed in the inner peripheral surface. A cylindrical member is rotatably engageable into the housing, and has an outer peripheral slot to receive a retaining ring which may rotatably couple and secure the cylindrical member to the housing. The housing includes an inner peripheral recess formed in the inner peripheral surface, and the cylindrical member includes a peripheral flange rotatably engage into the inner peripheral recess of the housing, to prevent the cylindrical member from being vibrated and swung relative to the housing.

### BACKGROUND OF THE INVENTION

1. Field of the Invention

The present invention relates to a coupling assembly, and more particularly to a coupling assembly having a stable and solid swivel coupling device for coupling or attaching a key or an object to a coupling member.

2. Description of the Prior Art

Various kinds of typical swivel coupling devices have been developed and comprise a coupling member, such as a ring member rotatably or pivotally attached to a bonnet of a load, for allowing the load to be easily attached or hooked to hook members or ties with the coupling member or the ring member.

For example, U.S. Pat. No. 4,641,986 to Tsui et al. discloses one of the typical swivel coupling devices comprising a coupling member, such as a ring member including bent segments or pivot pins formed or provided on two ends, for rotatably or pivotally attaching to a bonnet of a load.

For coupling the coupling member or the ring member to the bonnet of the load, it is required to form spherical cavities or pocket recesses in the bonnet of the load, for rotatably receiving the bent segments or the pivot pins of the ring member. However, it will be difficult to form or to shape the spherical cavities or pocket recesses in the bonnet of the load. In addition, the ring member has only the two ends rotatably attached to the bonnet of the load, and may be easily disengaged from the bonnet of the load.

U.S. Pat. No. 4,665,592 to Kasai discloses another typical swivel coupling device comprising a coupling member, such as a ring-shaped portion rotatably or pivotally attached to two bearing halves of a hook member with an arm portion and an enlarged end, in which the enlarged end of the arm portion is required to be force-fitted into the bearing halves of the hook member, and thus may also have a good chance to be disengaged from the bearing halves of the hook member relatively.

U.S. Pat. No. 5,248,176 to Fredriksson discloses a further typical swivel coupling device comprising a coupling member, such as a ring member including bent leg end portions rotatably or pivotally attached to a rotary member with sleeves.

For coupling the coupling member or the ring member to the bonnet of the load, it is required to form L-shaped recesses in the rotary member, for rotatably receiving the bent segments or the of the ring member. However, similarly, it will be difficult to form or to shape the L-shaped recesses in the rotary member. In addition, the ring member also has only the two ends rotatably attached to the rotary member, and may be easily disengaged from the rotary member.

The present invention has arisen to mitigate and/or obviate the afore-described disadvantages of the conventional swivel coupling devices.

### SUMMARY OF THE INVENTION

The primary objective of the present invention is to provide a coupling assembly having a stable and solid swivel coupling device for coupling or attaching a key or other objects to a coupling member or a snap ring, and having a stable and solid coupling configuration for preventing the swivel coupling device from being easily damaged, and for increasing the working life of the swivel coupling device.

In accordance with one aspect of the invention, there is provided a coupling assembly comprising a coupling member, a swivel coupling device for attaching to the coupling member, the swivel coupling device including a housing having a chamber formed therein and defined by an inner peripheral surface, and having an inner peripheral groove formed in the inner peripheral surface thereof, and having a first ring member attached thereto, the swivel coupling device further includes a cylindrical member rotatably engageable into the chamber of the housing, and having an outer peripheral slot formed therein, and having a second ring member attached thereto for attaching to the coupling member, and a retaining ring is rotatably engaged onto the outer peripheral slot of the cylindrical member, and rotatably engaged into the inner peripheral groove of the housing, to rotatably couple and secure the cylindrical member to the housing, and to prevent the cylindrical member from being disengaged from the housing.

The housing further includes an inner peripheral recess formed in the inner peripheral surface thereof, and the cylindrical member further includes a peripheral flange radially and outwardly extended therefrom, to rotatably engage into the inner peripheral recess of the housing, and to stably attach the cylindrical member to the housing, and to prevent the cylindrical member from being vibrated and swung relative to the housing, such that the cylindrical member and the housing may further be prevented from being bent or damaged relative to each other.

The coupling member includes a first end having a channel formed therein and defined between two flaps, to rotatably receive the second ring member of the cylindrical member, the flaps each includes an orifice formed therein, and a coupler engaged through the orifices of the flaps and the second ring member of the cylindrical member, to rotatably couple and secure the swivel coupling device to the coupling member. An object, such as a portable phone or mobile phone, a remote control device, an ornament member, or a key may further be provided and attached to the first ring of the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a coupling member having a swivel coupling device in accordance with the present invention;

FIG. 2 is a partial exploded view illustrating an attachment or a pivotal coupling of the swivel coupling device to the coupling member;

FIG. 3 is a plan view of the swivel coupling device;

FIG. 4 is an exploded view of the swivel coupling device;

FIG. 5 is an exploded and cross sectional view of the swivel coupling device; and

FIG. 6 is a perspective view illustrating the operation of the swivel coupling device.

### DETAILED DESCRIPTION OF THE PREFERRED EMBODIMENT

Referring to the drawings, and initially to FIGS. 1-3, a coupling assembly in accordance with the present invention comprises a swivel coupling device 10 for rotatably or pivotally coupling or attaching an object 80 to a coupling member 70, such as for coupling or attaching a portable phone or mobile phone, a remote control device, an ornament member, or a key 80 to a hook, or a snap ring 70, or the like.

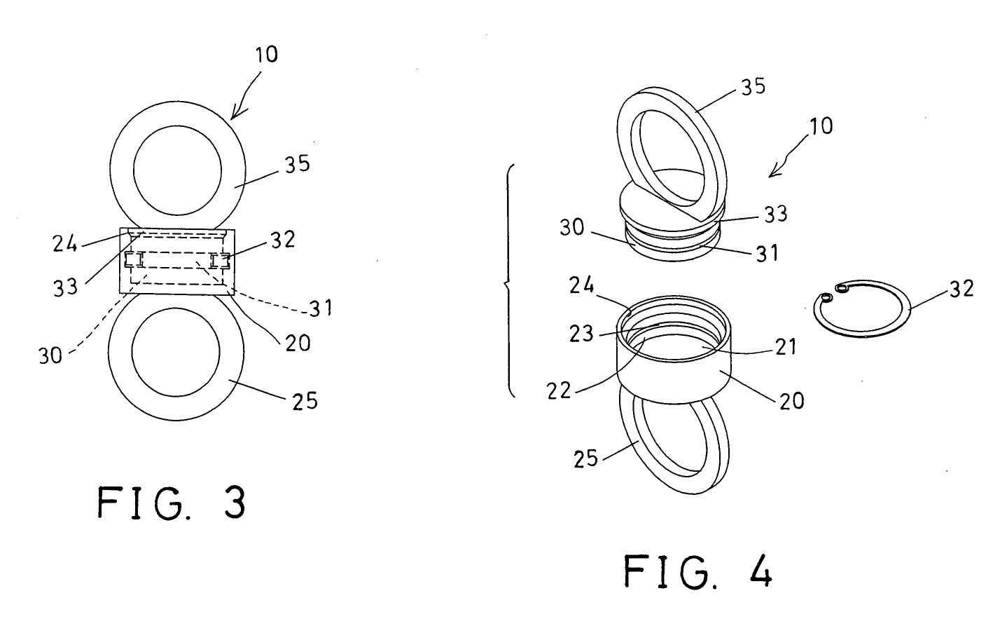

For example, as shown in FIGS. 3-5, the swivel coupling device 10 includes a housing 20 having a chamber 21 formed therein and defined by an inner peripheral surface 22, and having an inner peripheral groove 23 formed in a middle portion of the inner peripheral surface 22 thereof, and having an inner peripheral recess 24 formed in an upper or free end portion of the inner peripheral surface 22 thereof, and having a ring member 25 attached thereto, and preferably opposite to the chamber 21 thereof.

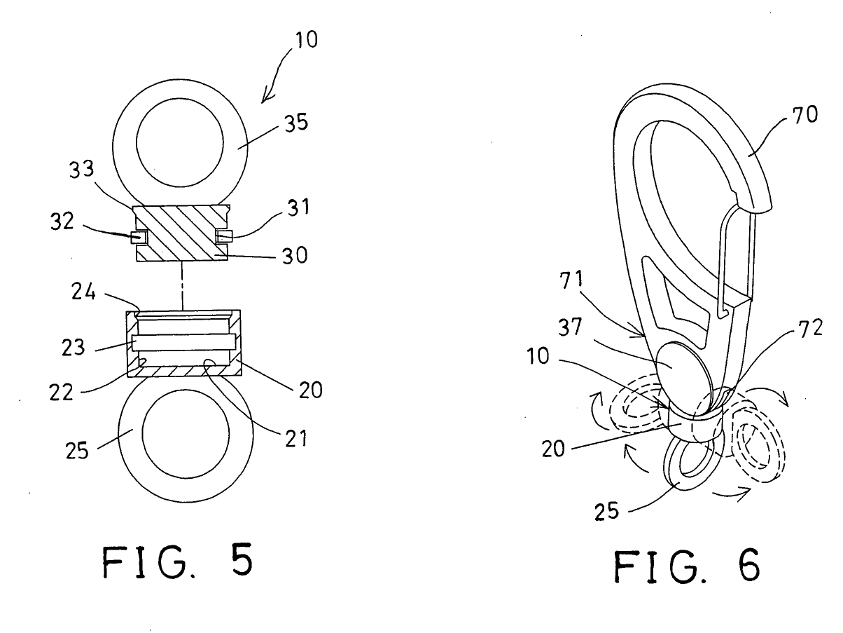

The swivel coupling device 10 further includes a cylindrical member 30 rotatably engageable into the chamber 21 of the housing 20, and having an outer peripheral slot 31 formed in an outer peripheral portion thereof, for receiving a clamping or retaining ring 32 (FIG. 5), and the retaining ring 32 may also be rotatably engaged into the inner peripheral groove 23 of the housing 20 (FIG. 3), to stably and rotatably couple and secure the cylindrical member 30 to the housing 20, and may prevent the cylindrical member 30 from being disengaged from the housing 20.

It is preferable that the cylindrical member 30 further includes a peripheral flange 33 radially and outwardly extended therefrom, for rotatably engaging into the inner peripheral recess 24 of the housing 20, and for further stably and rotatably attaching the cylindrical member 30 to the housing 20, and for further preventing the cylindrical member 30 from being vibrated or swung relative to the housing 20. The cylindrical member 30 also includes a ring member 35 attached thereto.

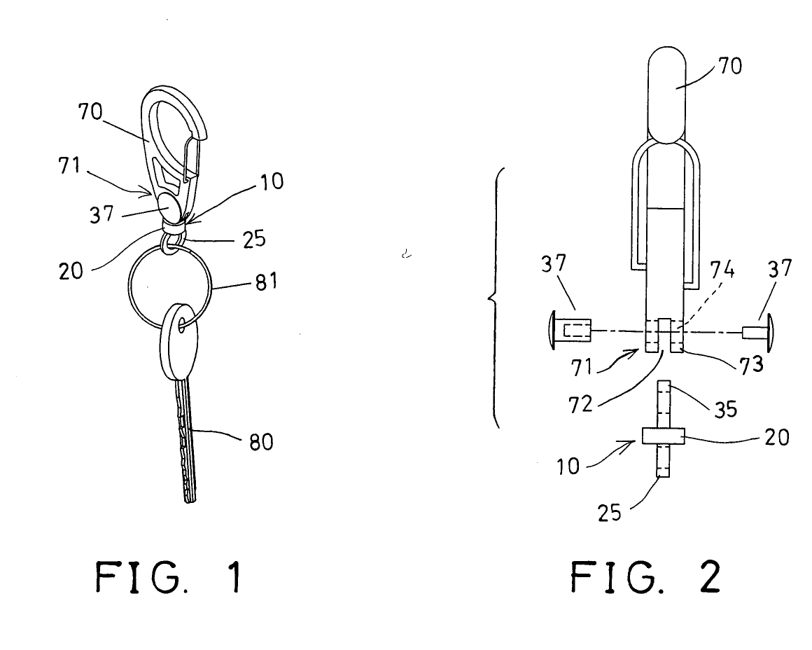

For example, as shown in FIG. 1, the object 80 or the portable phone or the mobile phone or the remote control device or the ornament member, or the key 80 may be coupled or attached to the ring member 25 of the housing 20 with such as a ring element 81. As shown in FIG. 2, the coupling member 70 or the snap ring 70 includes one end 71 having a channel 72 formed therein and defined between two flaps 73, to rotatably receive the ring member 35 of the cylindrical member 30, and the flaps 73 each includes an orifice 74 formed therein, for receiving a coupler 37 which may rotatably or pivotally couple or secure the swivel coupling device 10 to the snap ring 70 or the coupling member 70 (FIGS. 1, 6).

In operation, as shown in FIG. 6, the ring member 35 of the cylindrical member 30 of the swivel coupling device 10 may be rotated relative to the snap ring 70 or the coupling member 70; in addition, the cylindrical member 30 of the swivel coupling device 10 may also be rotated relative to the housing 20, such that the housing 20 and thus the portable phone or the mobile phone or the remote control device or the ornament member, or the key 80 or the other objects 80 may also be freely rotated relative to the cylindrical member 30 and thus the snap ring 70 or the coupling member 70 or the like.

It is to be noted that the rotatably engaging or coupling of the cylindrical member 30 into the chamber 21 of the housing 20 with the retaining ring 32 may stably couple the cylindrical member 30 to the housing 20, and may also prevent the cylindrical member 30 from being vibrated or swung relative to the housing 20, and thus may prevent the swivel coupling device 10 from being easily damaged, and may increase the working life of the swivel coupling device 10.

Accordingly, the coupling assembly in accordance with the present invention includes a stable and solid swivel coupling device for coupling or attaching keys or other objects to a coupling member, and having a stable and solid coupling configuration for preventing the swivel coupling device from being easily damaged or broken, and for increasing the working life of the swivel coupling device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A coupling assembly comprising:
a coupling member,
a swivel coupling device for attaching to said coupling member, said swivel coupling device including a housing having a chamber formed therein and defined by an inner peripheral surface, and having an inner peripheral groove formed in said inner peripheral surface thereof, and having a first ring member attached thereto,
said swivel coupling device further including a cylindrical member rotatably engageable into said chamber of said housing, and having an outer peripheral slot formed therein, and having a second ring member attached thereto for attaching to said coupling member, and
a retaining ring rotatably engaged onto said outer peripheral slot of said cylindrical member, and rotatably engaged into said inner peripheral groove of said housing, to rotatably couple and secure said cylindrical member to said housing, and to prevent said cylindrical member from being disengaged from said housing.

2. The coupling assembly as claimed in claim 1, wherein said housing further includes an inner peripheral recess formed in said inner peripheral surface thereof, and said cylindrical member further includes a peripheral flange radially and outwardly extended therefrom, to rotatably engage into said inner peripheral recess of said housing, and to stably attach said cylindrical member to said housing, and to prevent said cylindrical member from being vibrated and swung relative to said housing.

3. The coupling assembly as claimed in claim 1, wherein said coupling member includes a first end having a channel formed therein and defined between two flaps, to rotatably receive said second ring member of said cylindrical member, said flaps each includes an orifice formed therein, and a coupler engaged through said orifices of said flaps and said second ring member of said cylindrical member, to rotatably couple and secure said swivel coupling device to said coupling member.

4. The coupling assembly as claimed in claim 1 further comprising an object attached to said first ring of said housing.
